(19) United States
(12) Patent Application Publication
(10) Pub. No.: US 2004/0101357 A1
(43) Pub. Date: May 27, 2004

(54) Set of plates and a plate therefor

(76) Inventors: Hielke Dijkstra, Neede (NL); Hans Fransiscus Nelen, Eindhoven (NL)

Correspondence Address: Richard L Byrne, 700 Koppers Building, 436 Seventh Avenue, Pittsburgh, PA, 15219-1818, US

(21) Appl. No.: 10/332,097

(22) PCT Filed: Jul. 4, 2001
(86) PCT No.: PCT/NL01/00503

(30) Foreign Application Priority Data
Jul. 4, 2000 (NL) 1015605
Jun. 21, 2001 (NL) 1018352

(51) Int. Cl. F16B 1/00

(52) U.S. Cl. 403/403

(57) ABSTRACT

The invention relates to a set of plates, such as a wall, a stand and a container, comprising at least two plates which are provided with profiles on plate edges for coupling to each other, which profiles are provided with longitudinal structures securing against a transversal displacement for forming a form-fitting coupling between the two plates; and with lock means for locking and/or biasing the coupling, and to a plate provided with a profile and with lock means for this set of plates.

The present invention relates to a set of plates, and to a plate for such a set of plates.

A set of plates according to the invention can consist of a wall constructed from plates, a housing such as a WC-cabin, a stand which is constructed from plates usually connected at an angle, and an open or closed container.

In the case of a wall, a stand or a container for multiple use, it is important that this can be constructed from a set of plates. This set of plates must herein be secured as well as possible against mutual translation of plates.

Sets of plates which satisfy the above requirements do not appear to exist at the moment. The present invention therefore has for its object to provide a set of plates which can be applied as container, stand, wall and optionally cabin which comprises the above stated advantages.

This is achieved according to the invention with a set of plates which comprises:

at least two plates which are provided with profiles on plate edges for coupling to each other, which profiles are provided with longitudinal structures securing against a transversal displacement for forming a form-fitting coupling between the two plates; and with lock means for locking and/or biasing the coupling. By making use of plates which are provided on plate edges with longitudinal structures securing against transversal displacement, so that a form-fitting coupling can be realized which is secured with lock means, two plates in each case are pulled rigidly onto each other, whereby displacements transversely of the form-fitting coupling become impossible. The profiles are provided for this purpose with structures which can bring about a form-fitting coupling. A form-fitting coupling implies that after coupling there are in fact substantially no free spaces present any longer between the profiles and a good mutual transfer of forces is guaranteed. A transversal coupling is avoided here in that these structures are provided with co-acting complementary recesses and edges engaging therein. The profiles can be manufactured by performing folding or rolling operations on metal strips. The profiles can also be manufactured by extrusion or by a milling operation. The profiles can therefore consist of wood, metal, plastic and combinations thereof.

The plates can consist of wood, metal, plastic and the like, but may also consist of a laminate. Use can be made herein of a core of a honeycomb, for instance of cardboard, plastic such as polyester or of pressed wood fibre having arranged thereon on both sides a cover layer of for instance a plastic such as PUR.

It will be apparent that the plates can be mutually coupled or uncoupled quickly by operating the lock means.

According to a preferred embodiment the profiles are coupled via a coupling profile. This means that the profiles arranged on the plates can be of the same type and the coupling profile is provided with a counter-structure form whereby the same form-fitting coupling can still be realized. If in further preference a coupling angle between the coupled walls varies from 10° to 180°, an angled set of plates can be formed. This finds particular application in the case of the coupling profiles, wherein the coupling angles can be varied with standard plates, since the variable coupling angle is arranged in the coupling profile. A plurality of walls can also be coupled.

In such preferred embodiments a set of plates can also be realized wherein the longitudinal, transversally securing structures lie in the line of the plate. It is thus possible to construct a larger wall of plates coupled according to the invention lying mutually in line. An angle between these plates can also be realized if the longitudinal, transversally securing structures preferably lie at an angle to the plate.

If in further preference the profile encloses the plate edge with its profiled edges, an embodiment is obtained wherein in fact no protruding parts occur and the edge of the profile is moreover strengthened and crumbling of plate edges is avoided.

If it is further preferred that the edge of the plates is strengthened, it is recommended that:

the plate edge is provided with an insert profile and the lock means are preferably received in the insert profile.

If it is required that the set of plates has an improved watertightness, wind-proofing or sound-proofing, it is recommended that:

a profile and/or coupling profile is provided with sealing means.

For the erection of a set of plates according to the invention it is possible to operate the lock means via a plate surface. According to another embodiment it is possible to operate the lock means via a coupling profile.

According to a preferred embodiment the lock means engage in an opening formed in a profile. This profile is preferably the plate profile. The arranging of this opening in such a profile results in a lock means unit which is simple to design, while substantially no structural changes have to be made in the plates. In the case such an opening formed in the profile has insufficient sliding properties, strength and/or rigidity, it is further recommended that the opening be a wire-reinforced opening. A wire is herein fixed or formed around the opening. This results in a particularly advantageous situation if the wire-reinforced opening is arranged in a profile nose.

The positioning and placing of the lock means can take place more easily and more certainly if in further preference the lock means can be received in a profile guide. Nor in this case do any, or hardly any, changes have to be made to the plates.

A particular advantage results if in further preference the lock means are slidable in a carriage along the profile guide until the carriage is secured.

According to two preferred embodiments the lock means comprise a wedge and/or a catch which can be operated by a handle.

In order to avoid the lock means ceasing to function in undesired manner, it is further recommended that the lock means can be secured with a securing element, for instance the handle with which a catch of the lock means can be operated.

Finally, the invention relates to a plate which is provided on plate edges with the above stated profiles and with the lock means, which plate is evidently intended for the forming of a set of plates according to the invention.

Mentioned and other features of the invention will be elucidated hereinbelow on the basis of a number of embodiments, which are given only by way of example and without the invention being deemed limited thereto. Reference is made herein to the annexed drawings, in which:

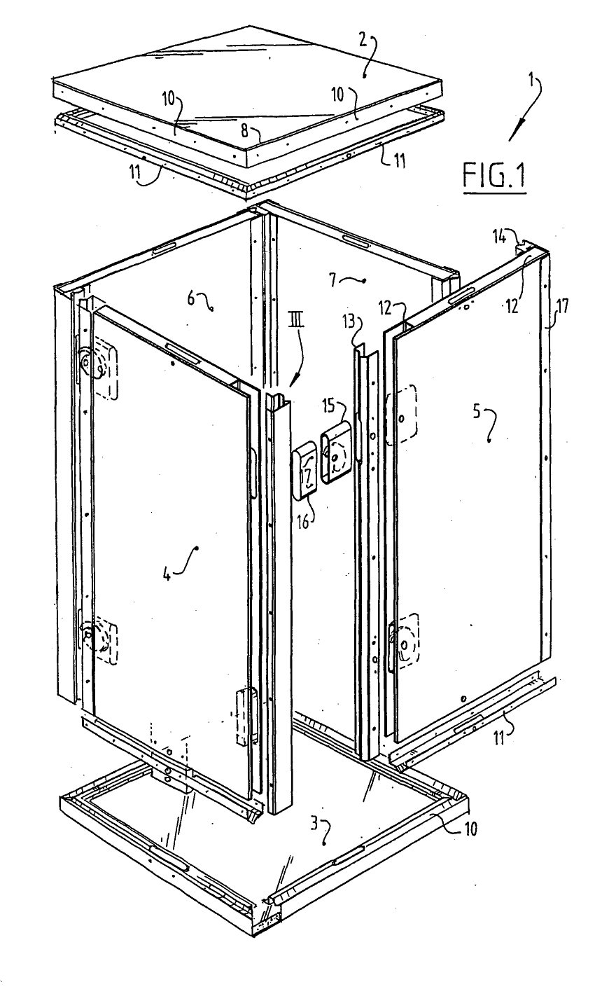

FIG. 1 shows a perspective, partly broken-away and partly exploded view of a set of plates as a container according to the invention;

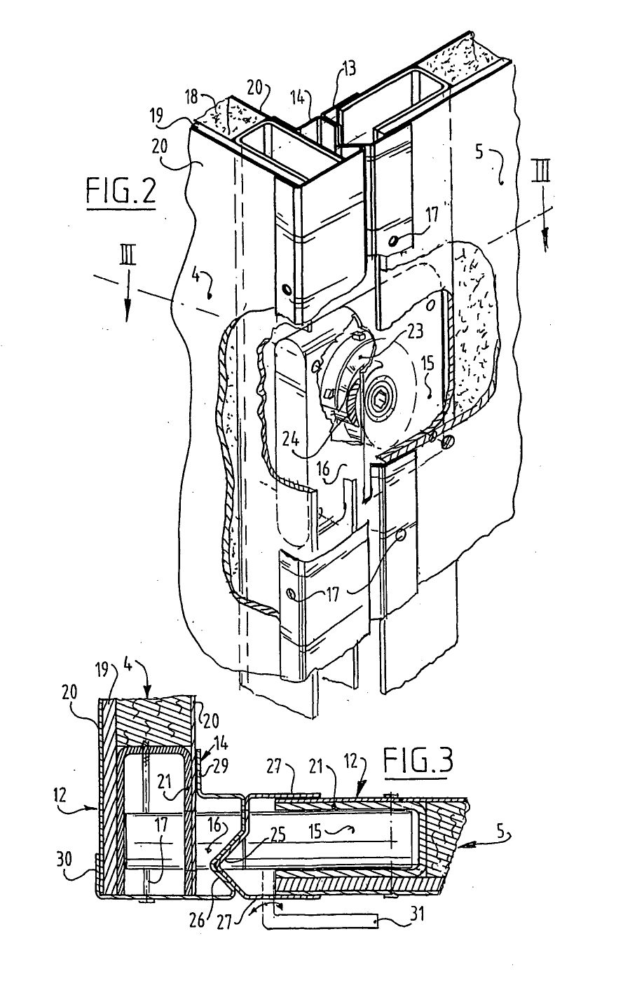

FIG. 2 shows on larger scale a partly broken-away view as according to detail II of FIG. 1;

FIG. 3 shows a cross-section along the angled line III-III of FIG. 2;

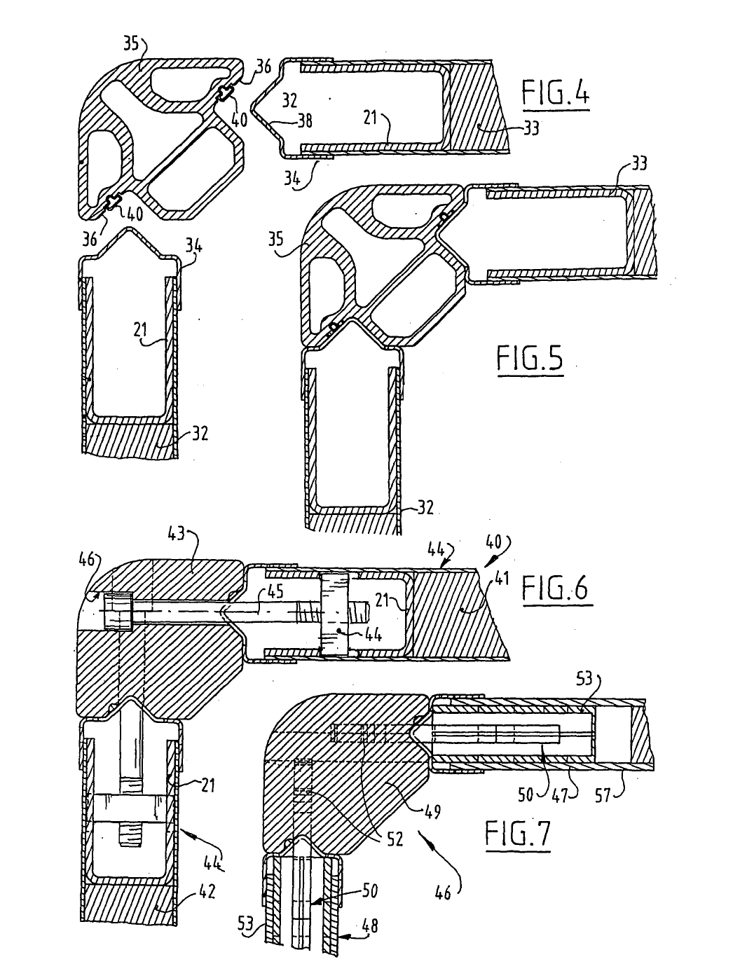

FIGS. 4-7 each show variants in cross-section of the embodiment shown in FIG. 3; and

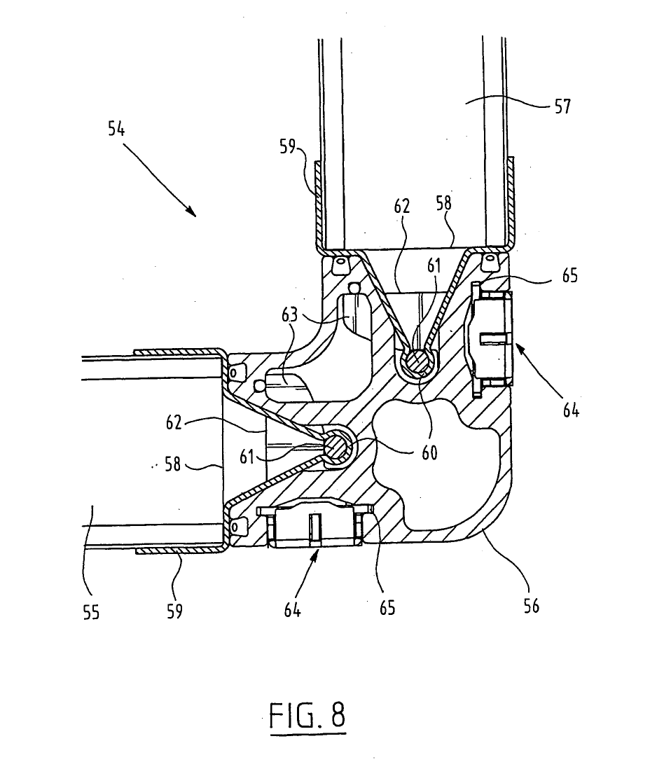

FIGS. 8-10 and FIGS. 11 and 12 show views of two other variants of a part of a set of plates according to the invention.

FIGS. 1-3 show a set of plates 1 or container 1 according to the invention. This container 1 comprises a cover plate 2, a bottom plate 3 and four wall plates 4-7. Cover plate 2 and bottom plate 3 are provided on the plate edges 8, 9 with profiles 10. Wall plates 4-7 are provided with complementary profiles 11 and on the longitudinal plate edges 12 with profiles 13 and 14.

Plates 2-7 are further provided with lock means. Profiles 2-7 and lock means 15, 16 are fixed to the corresponding plate using fastening means such as pop rivets or blind rivets 17.

FIG. 2 shows in more detail the coupling of plate 4 to plate 5.

Plates 4, 5 consist of a polyurethane core 18 which is provided on one side with a wood layer 19 and on both sides with a polyester top layer 20. On the longitudinal plate edges 12 the core 18 is partially removed, for instance by milling, and a steel insert profile 21 is arranged in the formed recess for the purpose of strengthening the longitudinal plate edge 12.

Lock means 15, 16 can be operated with a key 22, whereby an eccentric 23 engages in known manner behind an edge 24, whereby plates 4, 5 are pulled tightly onto each other and locked against a lateral as well as transversal displacement.

To this end the profile 13 is provided with a longitudinal edge 25 which is received in form-fitting manner in a recess 26 in profile 14. In addition to a good support of the profiles 13, 14 pulled tightly onto each other, a displacement transversely of profiles 13, 14 is also prevented by longitudinal edge 25 and recess 26. It can clearly be seen that profile 13 with its profile edges 27, 28 and profile 14 with its edges 29, 30 enclose the longitudinal edges 12 of both plates 4, 5. This produces a good, smooth and safe finish and also, using the insert profiles, a tubular strengthening.

It will further be apparent that by placing the recess 26 obliquely relative to plate 4, the plates 4 and 5 can be coupled at an oblique angle, i.e. an acute or obtuse angle.

FIGS. 4 and 5 show a set of plates 31 according to the invention which can for instance be used for a stand. In this case the plates 32 and 33 are each provided with the same type of profile 34 which is fastened in the same manner as profile 13 to the respective plates 32 and 33. Plates 32 and 33 are coupled via a coupling profile 35 which is provided with a structure 36 complementary to structure 37 of profile 34 which is provided with a protruding edge 38. The structure 36, which is provided with groove 39 for edge 38, is also provided with a rubber sealing strip 40. A watertight, soundproof or wind-proof coupling can hereby be realized. In FIG. 5 the plates 32, 33 are coupled to profile 35 using lock means (not shown).

It will further be apparent that with a displacement of the structures 36 in the coupling profile the right angle shown in FIG. 5 can vary between an acute angle and an obtuse angle as well as forming an in-line coupling of plates 32, 33.

FIG. 6 shows a set of plates 40 according to the invention consisting of the plates 41 and 42 and the solid coupling profile 43. In this case the lock means 44 are shown. The lock means comprise a nut 44 mounted in insert profile 21 and a bolt 45 which is screwed therein and which can be operated via a recess 46 in coupling profile 43.

Finally, FIG. 7 shows a set of plates 46, which can for instance be used for a cabin wall. The set of plates 46 comprises two plates 47 and 48 and coupling profile 49. Lock means 50 can be operated from a plate surface 51 and hook behind an edge 52 incorporated in coupling profile 49. It is noted that no use is made of insert profile 21 in the set of plates 46. The reinforcement is produced in this case at the position of the lock means by housing 53 of lock means 50.

FIG. 8 shows in cross-section another set of plates 54 according to the invention, wherein a plate 55 is coupled via a coupling profile 56 to a plate 57. Plate 55 and plate 57 are each provided on a plate edge 58 with a plate profile 59. The plate profile has a roundly-formed profile nose 60 which is strengthened with a steel wire 61.

In the nose of profile 59 is formed an opening 62 in which a wedge-shaped catch 63 of lock means 64 engages on wire 61. Owing to the wedge shape of catch 63 the plates 55 and 57 are pulled tightly onto corner profile 56. Wire 61 not only acts here as strengthening but also for a resilient bias in this coupling. Finally shown is that lock means 64 are guided slidably in a guide 65 arranged in longitudinal direction in corner profile 56.

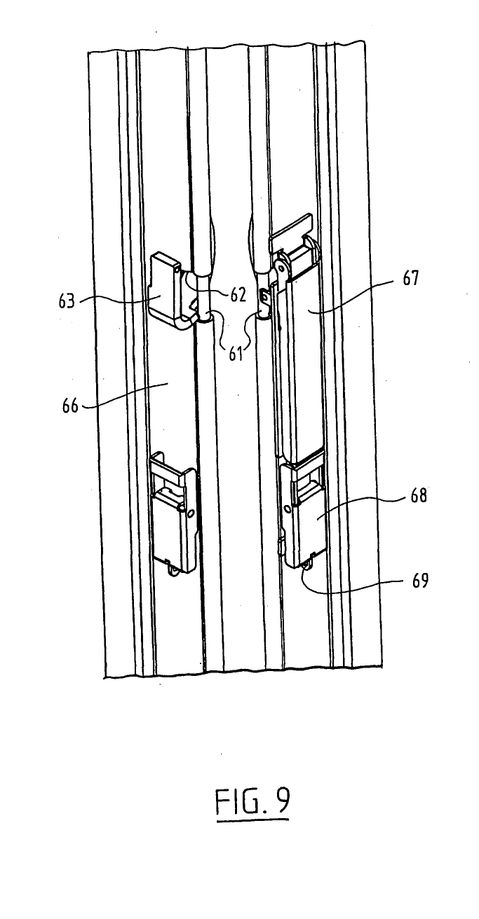

FIG. 9 shows various aspects in side view. Lock means 64 comprise a lock carriage 66 which is guided in guide 65 and is provided with a catch 63 mounted rotatably thereon and operable with a handle 67. Handle 67 is provided with a bent edge 68 which can grip behind a securing element 73 which is guided on carriage 66 and which is provided with an eye 69 in which securing means (not shown), for instance a lock, can be mounted, whereby translation of securing element 73 is blocked. Using lips 69 for bending outward, the lock carriage 66 can be fixed in the guide.

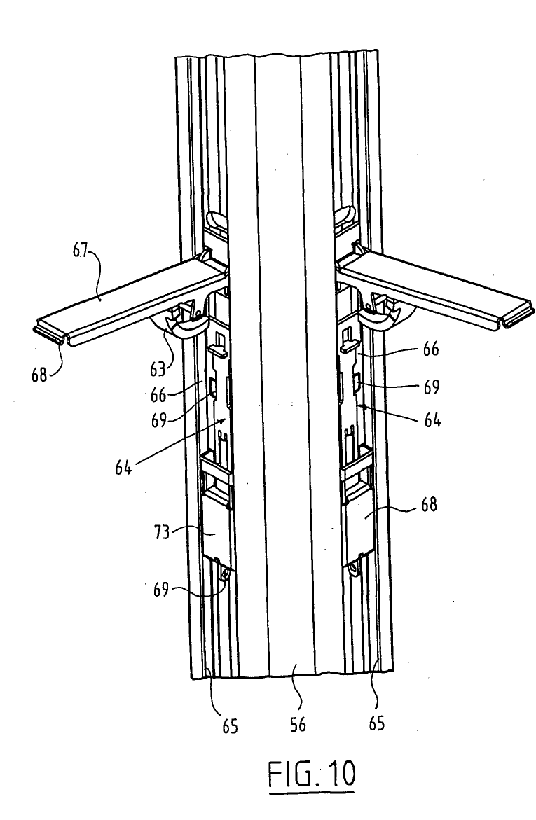

FIG. 10 shows in more cut-away state the lock means 64 in the closed position.

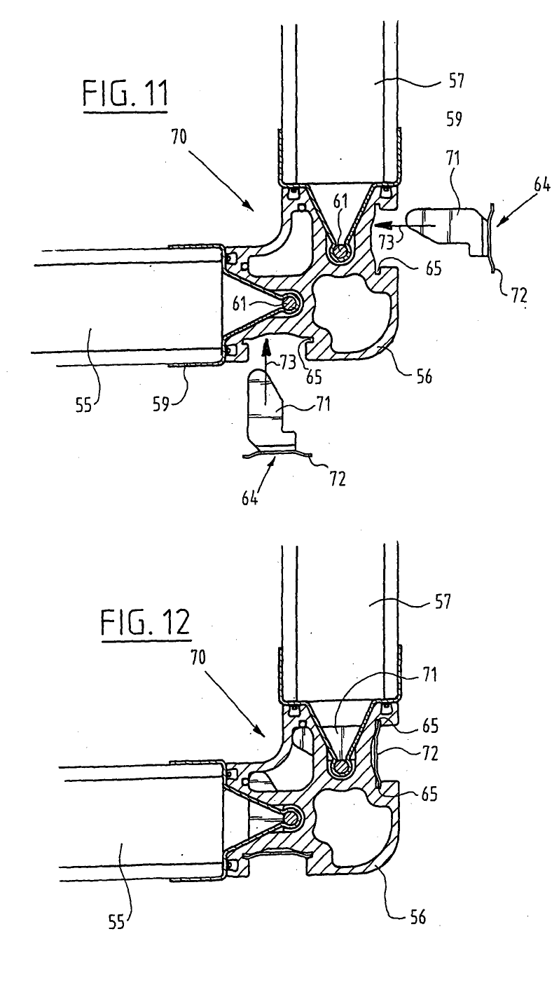

FIGS. 11 and 12 show another plate system 70 according to the invention. Compared to the plate system 54 of FIGS. 8-10, lock means 64 here comprise a wedge 71 provided with a resilient guide plate 72. Wedge 71 engages in the wire-strengthened opening 62 through displacement in the direction of arrow 73. The situation of FIG. 12 is hereby reached in which the guide plate 72 of wedge 71 has snapped into guide 65. A coupling which is once again ensured is hereby realized between plates 55 and 57 via corner profile 56.

1. Set of plates, such as a wall, a stand, a housing and a container, comprising:
at least two plates which are provided with profiles on plate edges for coupling to each other, which profiles are provided with longitudinal structures securing against a transversal displacement for forming a form-fitting coupling between the two plates; and with lock means for locking and/or biasing the coupling.

2. Set of plates as claimed in claim 1, wherein profiles are coupled via a coupling profile.

3. Set of plates as claimed in claim 1 or 2, wherein a coupling angle between the coupled walls varies from 10° to 180°.

4. Set of plates as claimed in claims 1-3, wherein the longitudinal, transversally securing structures lie in the line of the plate.

5. Set of plates as claimed in claims 1-3, wherein the longitudinal, transversally securing structures lie at an angle to the plate.

6. Set of plates as claimed in claims 1-5, wherein the profile encloses the plate edge with its profiled edges.

7. Set of plates as claimed in claims 1-6, wherein the plate edge is provided with an insert profile and the lock means are received in the insert profile.

8. Set of plates as claimed in claims 1-7, wherein a profile and/or coupling profile is provided with sealing means.

9. Set of plates as claimed in claims 1-8, wherein the lock means can be operated via a plate surface.

10. Set of plates as claimed in claims 2-8, wherein the lock means can be operated via the coupling profile.

11. Set of plates as claimed in claim 9 or 10, wherein the lock means engage in an opening formed in a profile.

12. Set of plates as claimed in claim 11, wherein the opening is arranged in a wire-reinforced profile part, for instance a profile nose.

13. Set of plates as claimed in claims 9-12, wherein the lock means can be received in a profile guide.

14. Set of plates as claimed in claim 13, wherein the lock means are slidable in a carriage along the profile guide.

15. Set of plates as claimed in claims 9-14, wherein the lock means comprise a wedge and/or a catch which can be operated with a handle.

16. Set of plates as claimed in claim 15, wherein the handle can be secured with a securing element.

17. Set of plates as claimed in claims 9-16, wherein the lock means are provided with securing means.

18. Plate provided with a profile and with lock means for a set of plates as claimed in claims 1-17.
